(19) United States
(12) Patent Application Publication
(10) Pub. No.: US 2013/0094817 A1
(43) Pub. Date: Apr. 18, 2013

(54) System of at Least One Assembly Comprising at Least One Integrated Circuit, the Said Integrated Circuits Being Interconnected According to a Matrix Architecture, Featuring at Least One Optical Interconnection

(71) Applicant: THALES, Neuilly-sur-Seine (FR)

(72) Inventors: Yann OSTER, Frouzin (FR); Michel SOTOM, Toulouse (FR); Norbert VENET, La Salvetat Saint Gilles (FR)

(73) Assignee: THALES, Neuilly-sur-Seine (FR)

(21) Appl. No.: 13/650,795

(22) Filed: Oct. 12, 2012

(30) Foreign Application Priority Data
Oct. 14, 2011 (FR) 11 03141

(51) Int. Cl. G02B 6/43

(52) U.S. Cl. 385/89

(57) ABSTRACT

A system of one or more integrated circuits is interconnected to a matrix architecture of rows and columns, a row receiving at least one input for signals, and a column providing at least one output for signals, the interconnections between two integrated circuits of a row and the interconnections between two integrated circuits of a column being electrical, and an assembly of at least one integrated circuit comprising at least one input integrated circuit and at least one output integrated circuit, an input integrated circuit being optionally an output integrated circuit, and at least one optical interconnection connecting an input of a row of the system to a respective input of the input integrated circuits of the assemblies, belonging to said row, or for connecting an output of a column of the system to a respective output of the output integrated circuits of the assemblies, belonging to the said column.

### CROSS-REFERENCE TO RELATED APPLICATION

This application claims priority to foreign French patent application No. FR 1103141, filed on Oct. 14, 2011, the disclosure of which is incorporated by reference in its entirety.

### FIELD OF THE INVENTION

The present invention pertains to a system of at least one assembly comprising at least one integrated circuit, the said integrated circuits being interconnected according to a matrix architecture of N rows and M columns of integrated circuits.

### BACKGROUND

Systems of at least one assembly of at least one integrated circuit are known, the said integrated circuits being interconnected according to a matrix architecture of integrated circuits, in which the integrated circuits are linked together by electrical connections, some being of high-throughput fast serial interface type, of frequency considerably greater than 100 MHz.

The expression integrated circuit is intended to mean an electronic component carrying out a more or less complex electronic function, and often integrating several types of elementary electronic components in a package of reduced volume. Logic gates are the simplest digital integrated circuits, microprocessors and memories figure among the most complex. There are integrated circuits dedicated to specific applications such as application specific integrated circuits or ASICs, notably for signal processing; one then speaks of digital signal processor or DSP. An important family of integrated circuits is that of the programmable logic component or FPGA for “Field Programmable Gate Array”.

The expression hybrid module is intended to mean a component integrating into one and the same package an assembly of interconnected circuits, optionally embodied in various technologies, and being able to process signals of various natures (analogue, radio-frequency, digital, optical).

The processing tasks are farmed out to a plurality of operators, which may be integrated circuits, hybrid modules or circuits, which are assembled on electronic cards within items of equipment. In what follows, the term integrated circuit is used also for hybrid modules.

In what follows, the organization in rows or in columns results from an arbitrary choice, the role of the rows and columns being freely permutable.

Considering processing tasks carried out on an assembly of circuits organized column-wise, the primary source inputs of a row of the system are transmitted to the whole assembly of columns, therefore to the whole assembly of integrated circuits of the same row. With electrical interfaces of point-to-point fast serial type, a known technique consists in propagating the source data gradually over one and the same row, an integrated circuit transmits the data received on its source inputs to the following integrated circuit of the same row, and carries out processing tasks whose results are transmitted to the following circuit of the same column. FIG. 1 illustrates such an example, in which the system comprises assemblies of at least one integrated circuit CI, the said integrated circuits being interconnected according to a matrix architecture of n1 rows Li and n2 columns Cj of integrated circuits CI, in this instance identical. The system represented comprises 3n1 inputs or data pathways and 4n2 outputs, since, in this instance the integrated circuits CI each have 3 inputs and 4 outputs or processing pathways.

The main benefit of such a system resides in its functional simplicity and its modularity. In particular, the numbers of inputs and outputs of the system may be adjusted by adding rows or columns. On the other hand, for complex requirements, this type of system calls upon a large number of integrated circuits and electronic cards, and a large number of interconnections and interfaces. This type of system consumes a great deal of energy, and requires significant area and significant mass, a large share of which is due to the interfaces themselves.

American patent application US 2005/0256969 A1 pertains to the electrical interconnection of digital circuits with fast serial links, integrating a packet switch within each circuit. Thus, it discloses a reconfigurable architecture based on programmable gate arrays or FPGAs.

Document U.S. Pat. No. 4,811,210 is aimed at implementing various functions and various types of algorithms, on one and the same computer, using a reconfigurable and parallel architecture. The proposed solution comprises groups of processors integrating respectively an optical switch to configure and modify the interconnections within the group and optical switches for exchanges between the groups.

This mode of hardware organization is not very appropriate for a matrix architecture with hard-wired logic specific for an application, and does not make it possible notably to reduce the complexity and energy consumption thereof.

Document U.S. Pat. No. 4,696,059 is aimed at implanting functions for fast signal processing (programmable filter, word generator, programmable delay line), whereas the elementary delay functions are either insufficiently fast, or not adjustable. The proposed solution comprises an optoelectronic switch and groups of delay functions, either electrical or optical. The elements, in optical technology, make it possible to achieve the speed requirement of the elementary delay function. The switch makes it possible to dynamically configure the connectivity between the primary inputs and the inputs/outputs of the delay functions, so as to synthesize various delay values, to construct filters or word generators.

This architecture does not make it possible to construct a complex matrix system comprising a large number of operators and of integrated circuits and carrying out complex processing tasks.

### SUMMARY OF THE INVENTION

An aim of the invention is to alleviate the problems cited above.

There is proposed, according to one aspect of the invention, a system of at least one assembly of at least one integrated circuit, the said integrated circuits being interconnected according to a matrix architecture of N rows and M columns of integrated circuits. A row receives at least one input for signals, and a column provides at least one output for signals. The interconnections between two integrated circuits of a row of one and the same assembly and the interconnections between two integrated circuits of a column of one and the same assembly are electrical. An assembly of at least one integrated circuit comprises at least one input integrated circuit comprising at least one input of the said assembly and at least one output integrated circuit comprising at least one output of the said assembly, an input integrated circuit being able also to be an output integrated circuit. Furthermore, the system comprises at least one optical interconnection for connecting an input of a row of the system to a respective input of the input integrated circuits of the assemblies belonging to the said row, or for connecting a respective output of the output integrated circuits of the assemblies belonging to a column of the system to the system output of the said column.

Such a system makes it possible to significantly reduce the requirement as regards fast serial interfaces within the integrated circuits, and as a consequence the energy consumption and complexity of implantation, in terms of quantity of circuits and of electronic cards. With a requirement reduced by up to half as regards the number of fast serial interfaces in the integrated circuits, this system allows better use of the resources and the input and output ports of the integrated circuits, and reduces the complexity of the equipment.

The use of optical links makes it possible generally to increase the bandwidth, and to drastically reduce the mass and bulkiness of the links and connectors.

In one embodiment, an assembly of at least one integrated circuit is implanted in a single electronic card.

Thus, the production of such a system may be carried out on the basis of a plurality of copies of one and the same card, thereby facilitating the production of the system and lowering its production cost.

According to one embodiment, an optical interconnection comprises an optical coupler and/or active optoelectronic coupling means and an optical link per input of input integrated circuit of the assemblies of a row or per output of output integrated circuit of the assemblies of a column.

Thus, the optical links make it possible to carry out simply the distributing of the signals at high-throughput from a point to a plurality of points, and/or to combine an assembly of outputs originating from several integrated circuits, without appreciably affecting the throughput and the quality of the signals at the interfaces.

Advantageously, at least one row optical interconnection comprises, furthermore, a test optical link.

Thus, it is possible to put in place non-intrusive test/monitoring means, to observe the signals without disturbing the operation of the system, or inject test signals into the system.

For example, an optical link comprises optical fibre.

The use of optical fibre makes it possible among other things to increase the bandwidth or the distance of transmission, to guarantee good isolation between the various links, or to facilitate the physical implantation of the links.

According to one embodiment, at least one row optical interconnection comprises, furthermore, an optical amplifier.

Thus, the power of the optical signal to be apportioned by the outputs of an optical coupler may be matched to suit the apportionment requirement, so as to guarantee the transmission performance of the links.

In one embodiment, several row optical interconnections may be linked at input by at least one optical switch, and/or several column optical interconnections may be linked at output by at least one optical switch.

It is thus possible to implement redundancy management, notably for onboard systems, for example embedded aboard satellites, by configuring optical switches, whose dissipation is independent of the throughputs processed.

According to one embodiment, at least one optical link is adapted for carrying out a wavelength division multiplexing.

In one embodiment, the system comprises at least one assembly of integrated circuits as redundancy, featuring optical links.

For example, the system such as described above may be adapted for carrying out a function of digital beam forming of phased array antenna, and/or for carrying out a switching function.

There is also proposed, according to another aspect of the invention, a processor comprising at least one system such as described above.

There is also proposed, according to another aspect of the invention, a satellite comprising at least one processor such as described above embedded aboard.

There is also proposed, according to another aspect of the invention, a method for interconnecting at least one assembly of at least one integrated circuit, according to a matrix architecture of n1 rows and n2 columns of integrated circuits, a row receiving at least one input for signals, and a column providing at least one output for signals, the interconnections between two integrated circuits of a row of one and the same assembly and the interconnections between two integrated circuits of a column of one and the same assembly being carried out electrically, and an assembly of at least one integrated circuit comprising at least one input integrated circuit comprising at least one input of the said assembly and at least one output integrated circuit comprising at least one output of the said assembly, an input integrated circuit being able optionally to be also an output integrated circuit. Furthermore, at least one input of a row of the system is interconnected optically to a respective input of the input integrated circuits of the assemblies, belonging to the said row, or at least one output of a column of the system is interconnected optically to a respective output of the output integrated circuits of the assemblies, belonging to the said column.

### BRIEF DESCRIPTION OF THE DRAWINGS

The invention will be better understood on studying a few embodiments described by way of wholly non-limiting examples and illustrated by the appended drawings in which:

FIG. 1 schematically illustrates an embodiment of a system with matrix architecture of at least one assembly of at least one integrated circuit, the said integrated circuits being interconnected according to a matrix architecture, with point-to-point links without distributing or direct recombination, according to the prior art, with point-to-point links without distributing or direct recombination;

FIG. 2 schematically illustrates a system with matrix architecture comprising at least one optical interconnection, according to one aspect of the invention;

FIG. 3 schematically illustrates a system with matrix architecture in which an assembly of at least one integrated circuit is included in a single electronic card according to one aspect of the invention;

FIG. 4 schematically illustrates a system with matrix architecture in which an assembly of at least one integrated circuit is included in a single electronic card, with test optical links, according to one aspect of the invention;

FIG. 5 schematically illustrates a system with matrix architecture in which the optical interconnections are solely according to the rows of the matrix architecture of the integrated circuits according to one aspect of the invention;

FIG. 6 schematically illustrates a system with matrix architecture for a satellite beamforming processor according to one aspect of the invention;

FIG. 7 schematically illustrates a system with matrix architecture with the assembly of the interconnections between integrated circuits which are of optical type, considering that each assembly of circuits comprises a single integrated circuit according to one aspect of the invention;

FIG. 8 schematically illustrates a system with matrix architecture comprising optical amplifiers according to one aspect of the invention;

FIG. 9 schematically illustrates a system with matrix architecture comprising optical switches according to one aspect of the invention;

FIG. 10 schematically illustrates a system with matrix architecture comprising an optical switch for a satellite beamforming processor according to one aspect of the invention;

FIG. 11 schematically illustrates a system with matrix architecture comprising a plurality of optical switches in parallel for a satellite beamforming processor according to one aspect of the invention;

FIG. 12 schematically illustrates a system with matrix architecture comprising optical switches between electronic cards for managing redundancies at the level of the electronic cards according to one aspect of the invention;

FIG. 13 schematically illustrates a system with matrix architecture comprising optical switches between columns for a satellite beamforming processor according to one aspect of the invention; and

FIGS. 14 to 18 schematically illustrate a switching of the redundancies mutualized separately per row (or sub-function), according to one aspect of the invention.

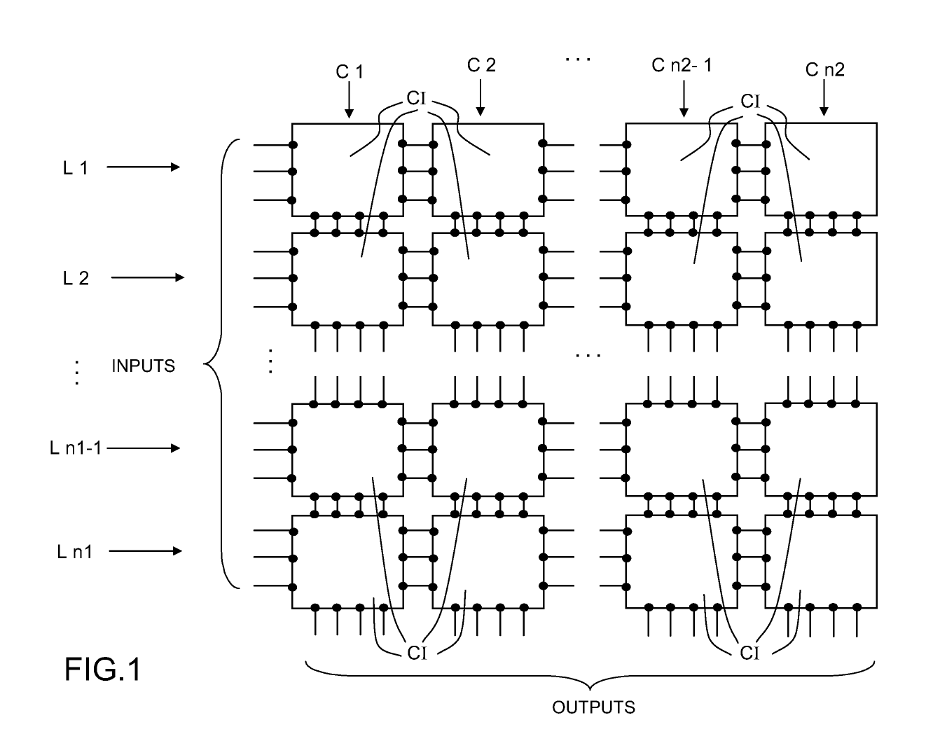

In all the figures, elements having identical references are similar.

### DETAILED DESCRIPTION

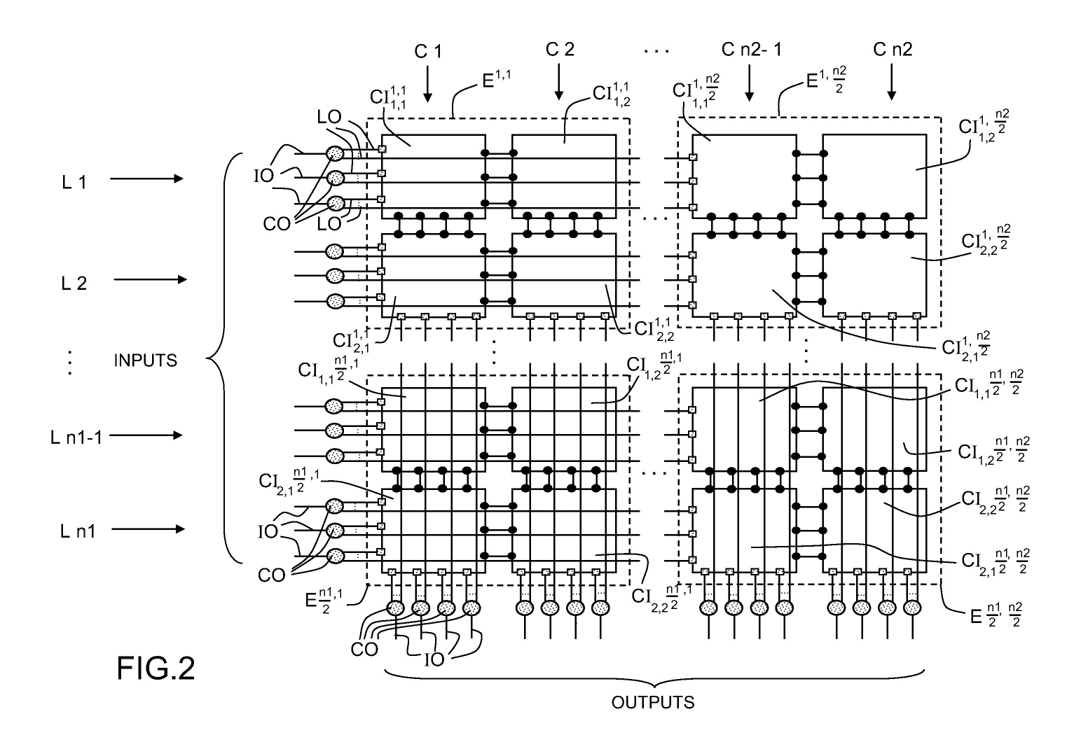

FIG. 2 schematically represents a system of at least one assembly E^{a,b}, in this instance E^{1,1}, . . . , E^{1,n2/2}, . . . , E^{n1/2,1}, . . . , E^{n1/2,n2/2} of at least one integrated circuit CI_{i,j}^{a,b}, in this instance four integrated circuits CI_{1,1}^{a,b}, CI_{1,2}^{a,b}, CI_{2,1}^{a,b}, CI_{2,2}^{a,b} (a integer varying from 1 to

$$\frac{n 1}{2}$$

and b integer varying from 1 to

$$\frac{n 2}{2} ) ,$$

the said integrated circuits CI_{i,j}^{a,b} (i integer varying from 1 to 2 and j integer varying from 1 to 2) being interconnected according to a matrix architecture of n1 rows and n2 columns of integrated circuits CI_{i,j}^{a,b}. Of course, this example of four integrated circuits per assembly E^{a,b} is wholly non-limiting, and the variations of the indices a and b of the assemblies E^{a,b} depend on the number of integrated circuits per assembly E^{a,b}.

A row k of integrated circuits (k integer varying from 1 to n1) receives at least one input for signals, in this instance three inputs, and a column I of integrated circuits (I integer varying from 1 to n2) provides at least one output for signals, in this instance four outputs.

The interconnections between two integrated circuits of a row k of one and the same assembly E^{a,b}, when this assembly comprises more than one integrated circuit per row, and the interconnections between two integrated circuits of a column I, when this assembly comprises more than one integrated circuit per column, are electrical.

An assembly E^{a,b} of at least one integrated circuit CI_{i,j}^{a,b} comprises at least one input integrated circuit, i.e. receiving input signals from outside the assembly, and at least one output integrated circuit, i.e. delivering output signals outside the assembly. An input integrated circuit can optionally be simultaneously an output integrated circuit. In this instance, in the example of FIG. 2, for an assembly E^{a,b}, the integrated circuits CI_{1,1}^{a,b} and CI_{2,1}^{a,b} are input integrated circuits, and the integrated circuits CI_{2,1}^{a,b} and CI_{2,2}^{a,b} are output integrated circuits. The circuit CI_{2,1}^{a,b} is simultaneously an input integrated circuit and an output integrated circuit for the assembly E^{a,b}.

The system comprises at least one optical interconnection IO, in this instance 3×n1+4×n2 optical interconnections, for connecting an input of a row of the system to a respective input of the input integrated circuits of the assemblies belonging to this row (3×n1 optical interconnections since in this example the integrated circuits all have three inputs belonging to optical interconnections), or for connecting an output of a column of the system to a respective output of the output integrated circuits of the assemblies belonging to this column (4×n2 optical interconnections since in this example the integrated circuits all have four outputs belonging to optical interconnections).

The optical interconnections IO each comprise an optical coupler CO and an optical link LO per input of input integrated circuit of the assemblies of a row (in this instance

$$\frac{n 2}{2}$$

optical links per coupler) or per output of output integrated circuit of the assemblies of a column (in this instance

$$\frac{n 1}{2}$$

optical links per coupler).

The expression optical coupler is intended to mean a passive optical device comprising one or more optical input ports and one or more optical output ports, apportioning each of the input signals over the whole assembly of output ports.

As a variant, it is possible to use, on emission, an active optoelectronic coupling device comprising an electrical input port and several optical emitters, each being connected to an optical output port, and apportioning the electrical input signal over the whole assembly of optical output ports.

As a variant, it is possible to use, on reception, an active optoelectronic coupling device, comprising several optical input ports each being connected to an optical detector and an electrical output port, and collecting the optical input signals towards the electrical output port.

In all the examples, the optical links LO can comprise optical fibre.

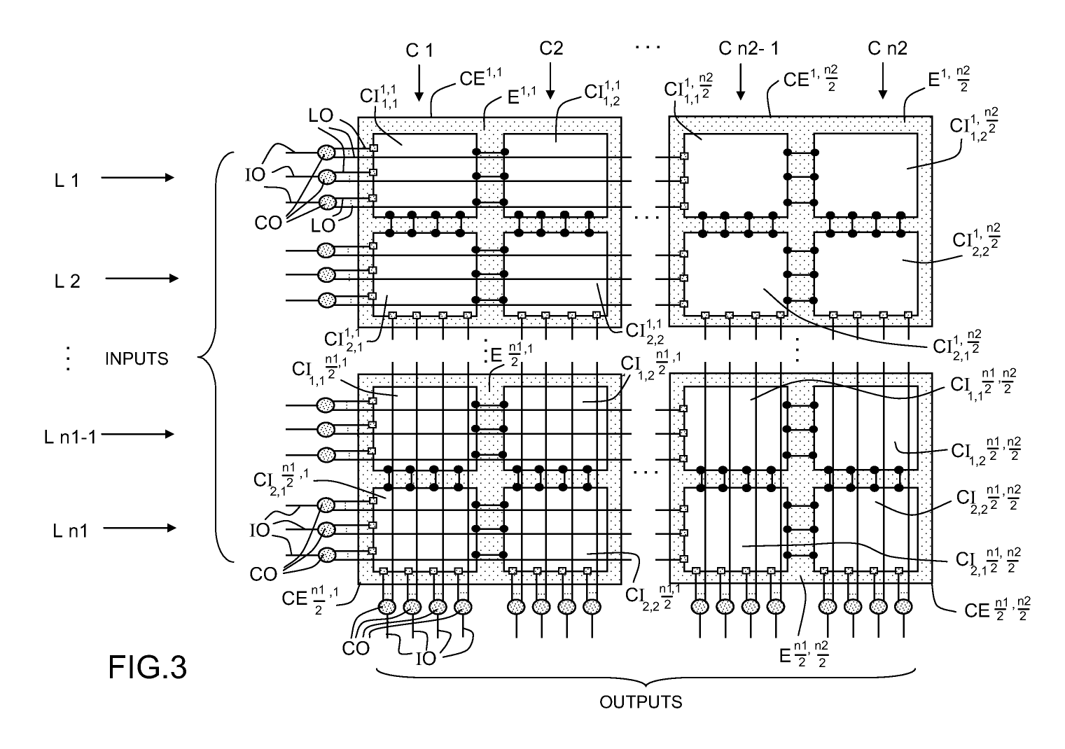

FIG. 3 represents a system similar to that of FIG. 2, in which an assembly E^{a,b} of at least one integrated circuit CI_{i,j}^{a,b} is included in a single electronic card CE^{a,b}. Thus, the cards may be produced in series identically, and thereafter be easily connected according to a matrix architecture, for example solely by optical interconnections IO. Of course, as a variant, just a fraction of these interconnections may be effected by optical interconnections.

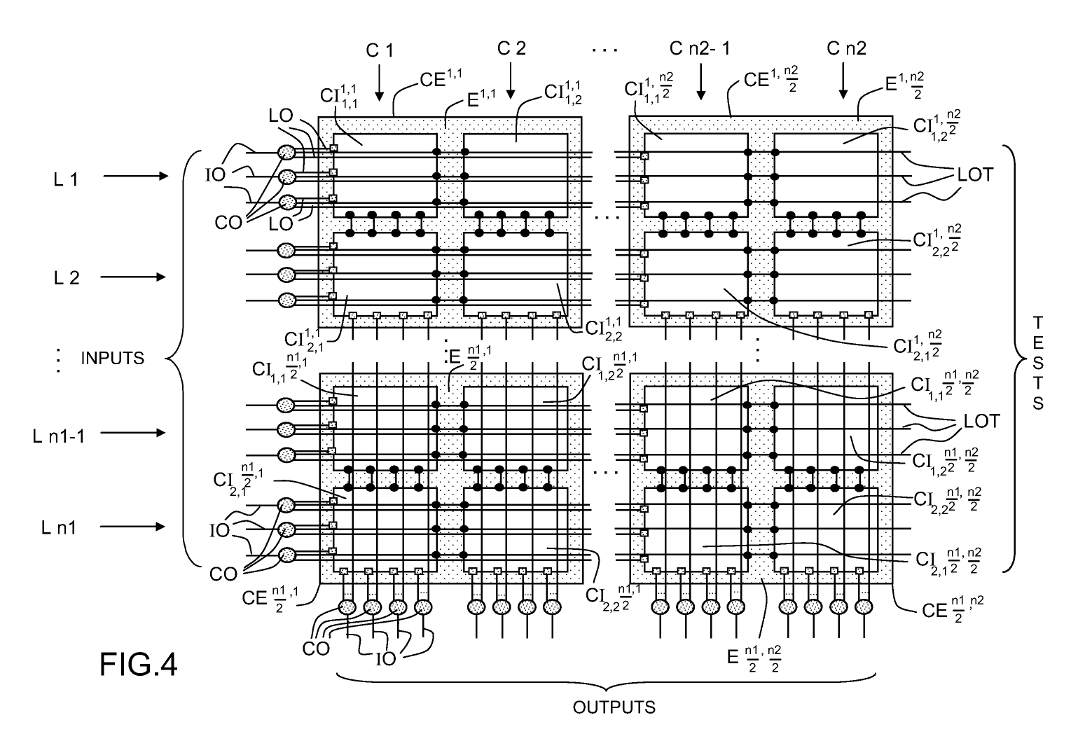

FIG. 4 represents a system similar to that of FIG. 3, in which the row optical interconnections IO comprise, furthermore, a test optical link LOT, in this instance so as to be able to observe the source data. Of course, as a variant, just a fraction of these row optical interconnections IO may comprise a test optical link LOT. The presence of such a test link makes it possible to be able to perform measurements in a non-intrusive manner on this row, this not being the case on high-throughput electrical interconnections which are disturbed by the instrumentation. As a variant, the row optical interconnections IO may comprise an additional test optical input, in this instance so as to be able to inject test data. The presence of such a test link makes it possible to be able to perform partial tests whilst the system is already assembled.

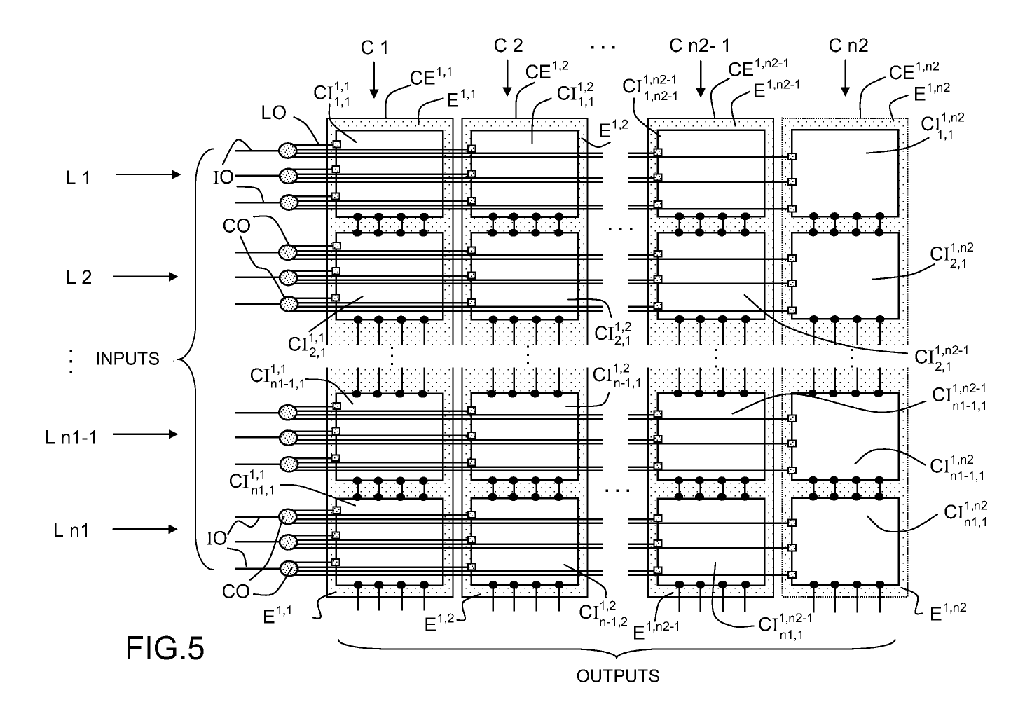

FIG. 5 represents a system similar to that of FIG. 3, in which the optical interconnections are solely according to the rows of the matrix architecture, and the electronic cards each comprise an assembly of n1 integrated circuits disposed column-wise. This configuration makes it possible to limit the electrical interconnections to just the interconnections internal to the electronic cards, and to effect all the interconnections between cards optically.

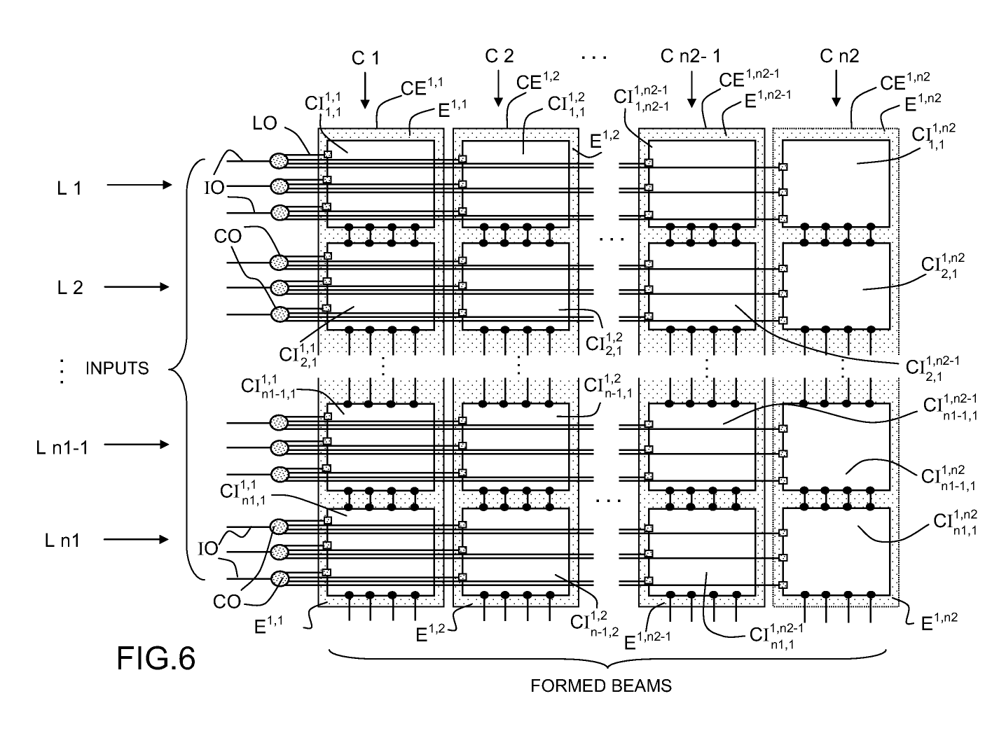

FIG. 6 represents a system similar to that of FIG. 5, for a satellite beamforming processor, in which the optical interconnections are solely according to the rows of the matrix architecture. Each column of integrated circuits produces an assembly of beam outputs on the basis of 3×n1 inputs of an array antenna, for example in reception. This modular architecture makes it possible to simply increase the number of beams by adding electronic cards processing the same inputs.

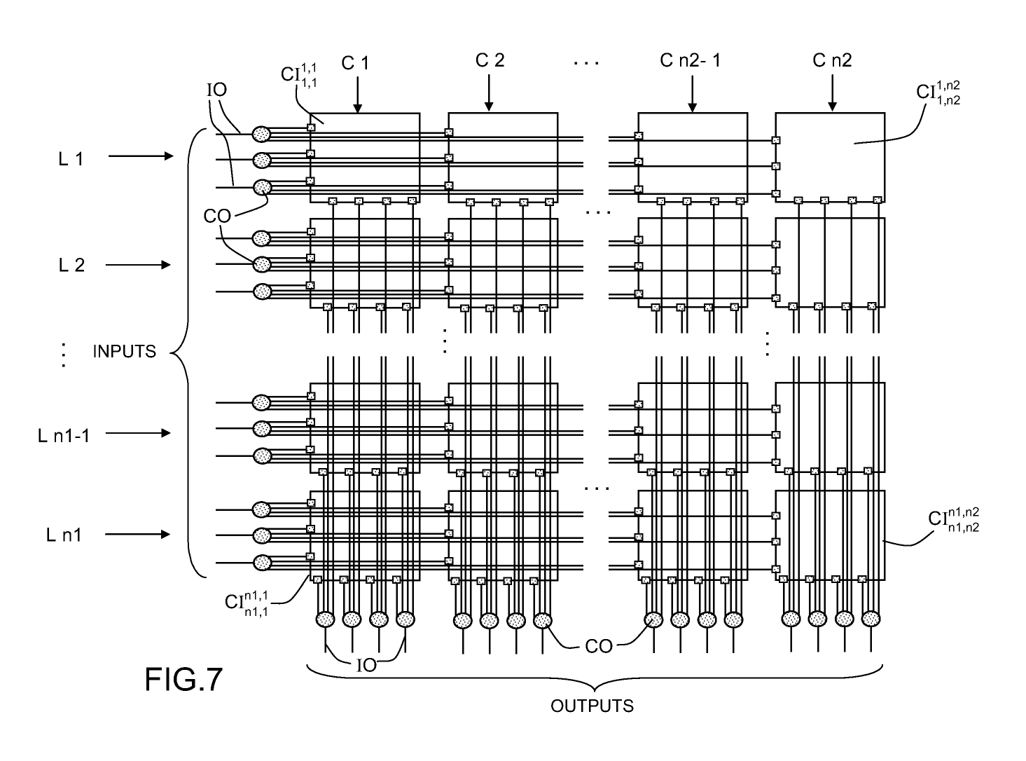

FIG. 7 represents a system with matrix architecture in which the assembly of the interconnections for all the integrated circuits, in rows and columns, are optical, considering that each assembly of integrated circuits comprises a single integrated circuit. This typical case corresponds to the generalization of the use of optical interfaces between integrated circuits so as to benefit from the capacity for distributing and direct recombination of the optical signals. The system can, for example, be embodied on a single card.

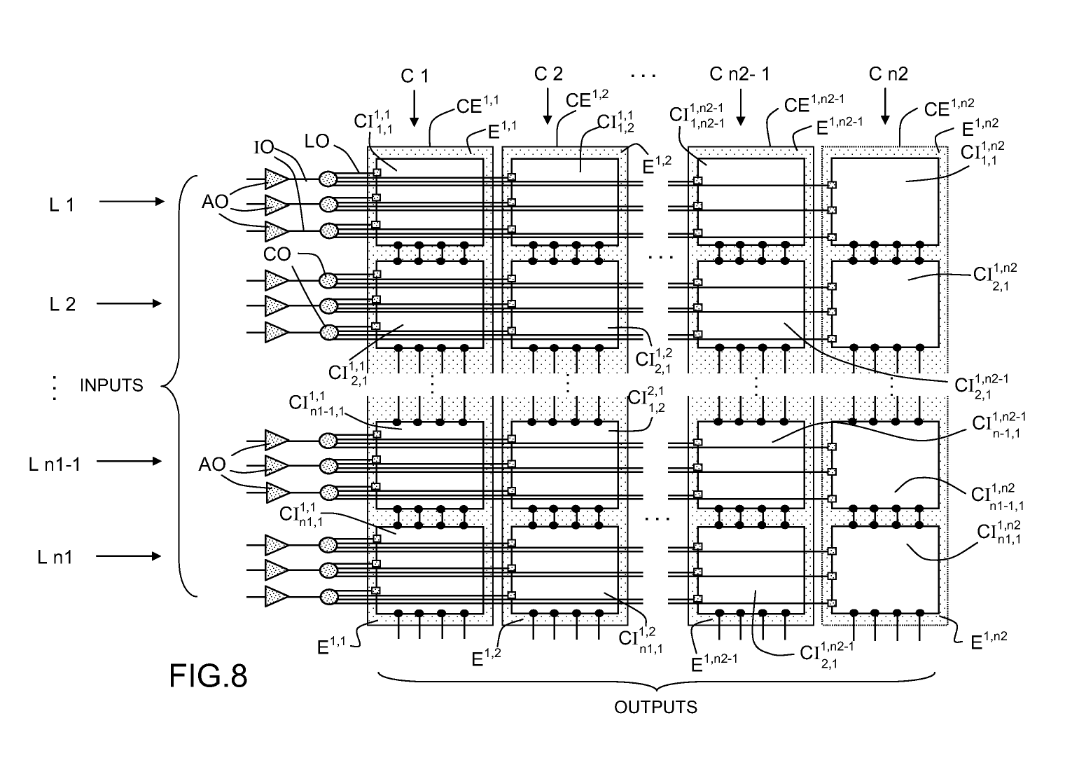

FIG. 8 represents a system with matrix architecture similar to that of FIG. 5, in which the optical interconnections are solely according to the rows of the matrix architecture, the electronic cards each comprise an assembly of n1 integrated circuits disposed column-wise, and optical amplifiers AO for compensating for the attenuation of the optical signals in the optical couplers.

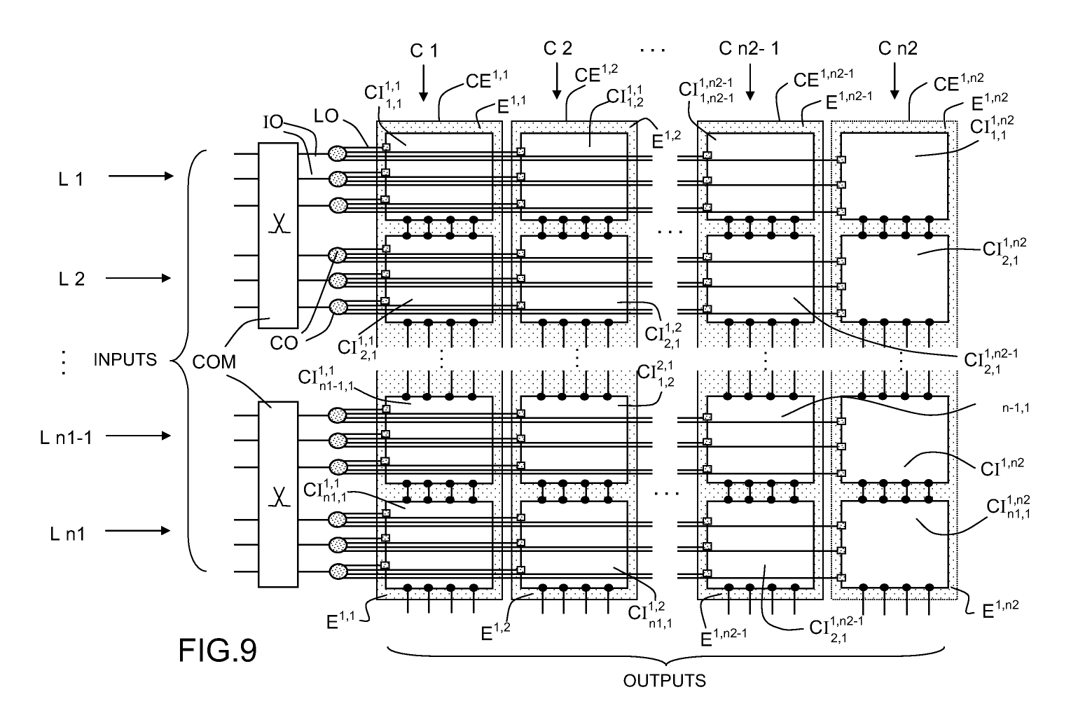

FIG. 9 represents a system with matrix architecture similar to those of FIGS. 5 and 8, comprising optical switches at input, making it possible to select, for reconfiguration requirements, the source inputs to be used.

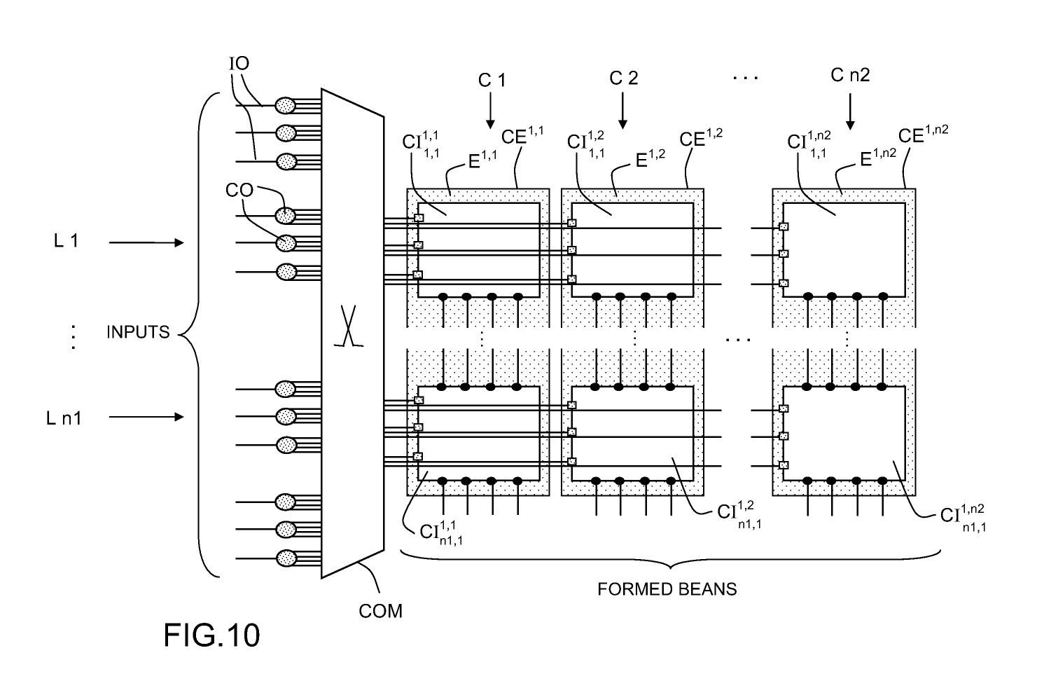

FIG. 10 represents a system with matrix architecture comprising an optical switch COM at input for a satellite beamforming processor. In this instance, the switch makes it possible to configure the association of the assemblies of source data, arising from radiating elements on reception or from beams on emission, with the assemblies of beam formers.

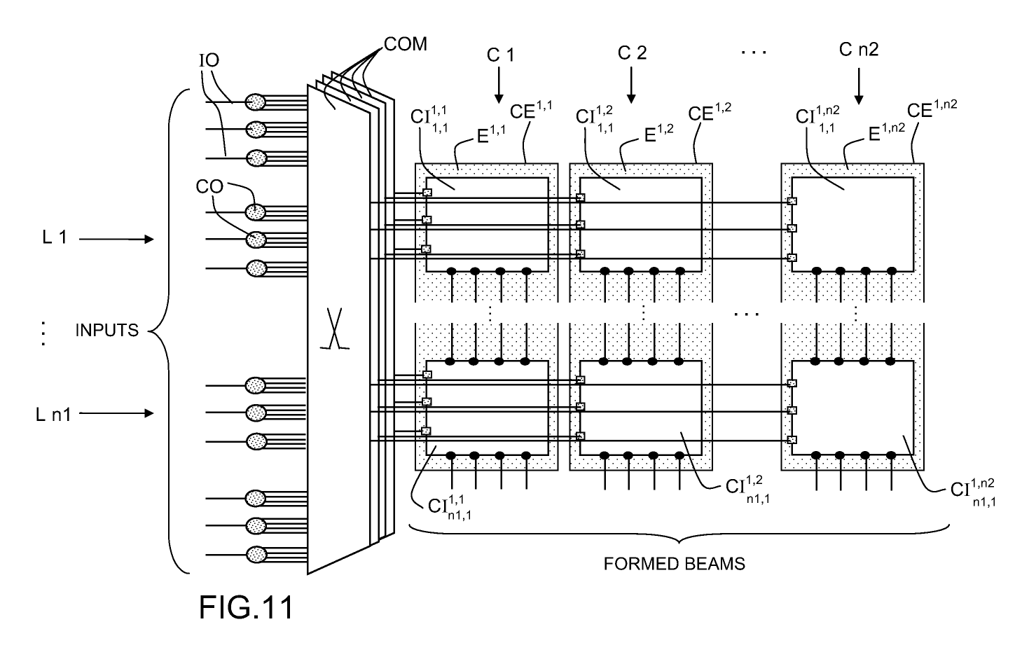

FIG. 11 represents a system with matrix architecture comprising a plurality of optical switches COM in parallel for a satellite beamforming processor. Employing certain limitations on the switching configurations for the optical links, by placing an assembly of optical switches in parallel it is possible to appreciably reduce the complexity of each switch.

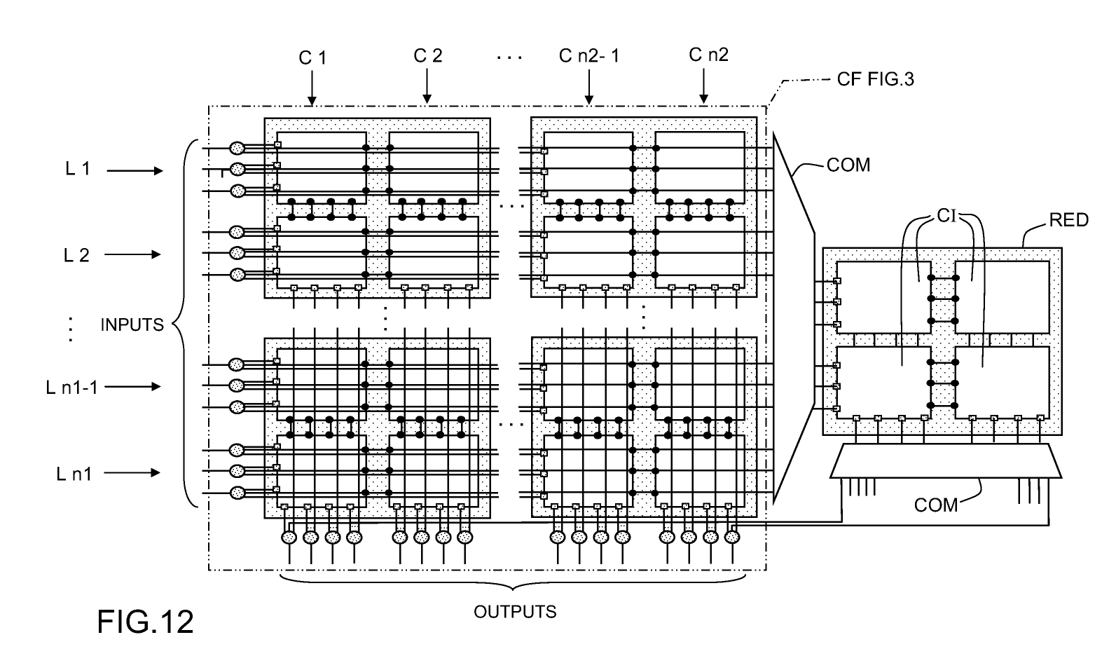

FIG. 12 represents a system with matrix architecture similar to that of FIG. 4, comprising optical switches COM between electronic cards for managing redundancies at the level of the electronic cards CE^{a,b}. This system makes it possible to substitute an unused card of the redundancy group RED for any electronic card exhibiting a failure.

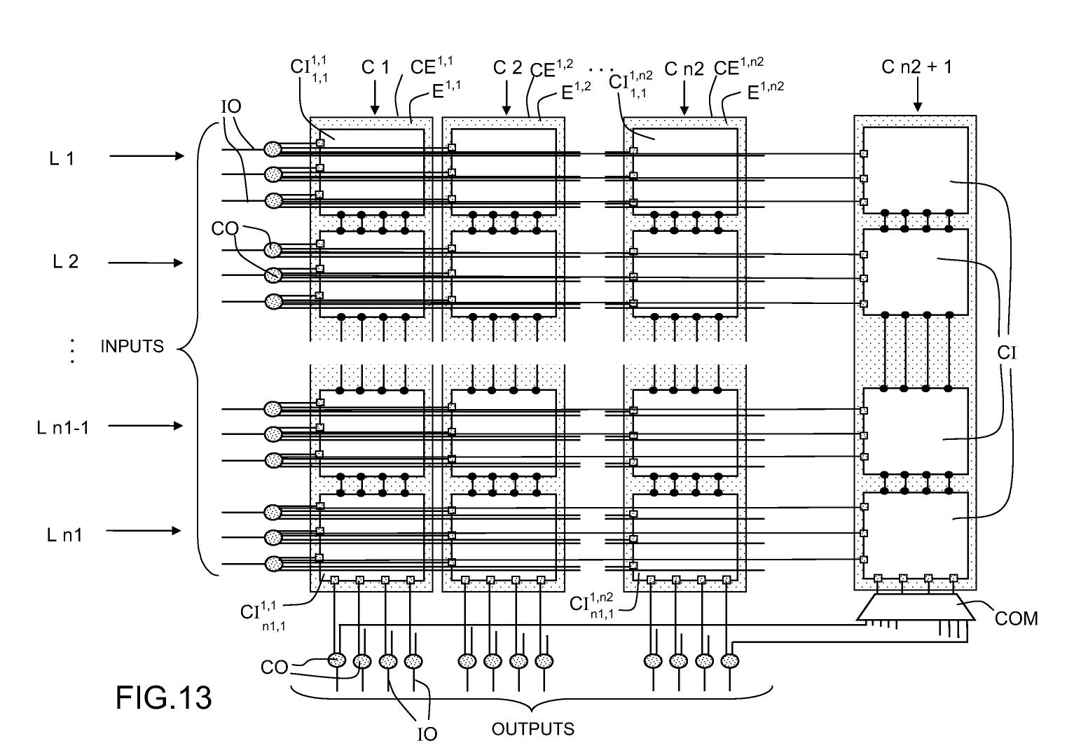

FIG. 13 represents a system with matrix architecture comprising an optical switch COM between columns for a satellite beamforming processor, the electronic cards CE^{a,b} each comprising an assembly of n1 integrated circuits disposed column-wise. The system comprises a redundancy of r columns of operators and a switching of these redundancies per entire column (function). The failure of an operator penalizes the whole of the processing pathway (vertical) and generally the whole of the column. This mode of redundancy switching consists in replacing the whole of the column impacted by an available redundant column. The r redundant columns (in this instance r=1 since the only redundancy column is column Cₙ₂₊₁) receive the data to be processed by optical distribution. The outputs of these redundant columns are selected via an optical switch COM (r columns of m=4 pathways, to M output pathways), whose M outputs feed as many optical couplers CO at the output of the nominal pathways. This then mobilizes a certain number of redundant operators (corresponding to the number of rows r×n1 of operators) so as to compensate for the failure of any r operators.

The optical apportionment of the signals lends itself to the switching of redundant operators, by using the capacity for distributing with the aid of optical couplers CO, and through the implementation of optical switches COM. The switching of the redundancies may be carried out in various ways: by entire column, by processing pathway, by electronic card or circuit, by row, or by data pathway, it being possible for the redundancies to be mutualized at various levels.

FIG. 13 illustrates a switching of the redundancies by entire column (or entire function)

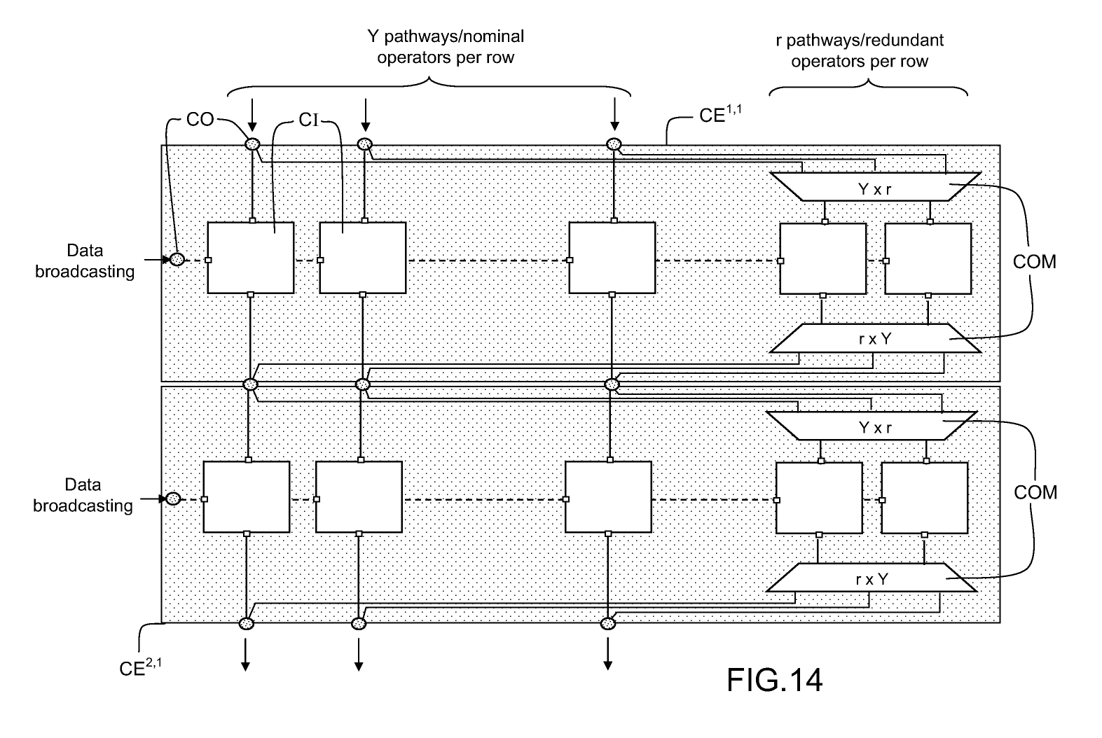

In FIGS. 14 to 18 are represented examples in which a row is embodied on a single electronic card.

FIG. 14 illustrates a switching of the redundancies mutualized separately per row (or sub-function). Such an embodiment consists in having r redundant operators within each row of operators, with a redundancy switching specific to each row. To simplify, FIG. 14 presents a single horizontal pathway for distributing the data per operator, as well as a single vertical processing pathway per operator. This schematic may be generalized with several horizontal data distribution pathways as well as several vertical processing pathways per row of operators.

Within a row of operators, the r redundant operators receive by optical distribution the data to be processed, like the Y nominal operators. In this configuration, the vertical processing pathways also comprise optical links.

Optical couplers CO with two inputs and two outputs are associated with the nominal operators so as to distribute the processed partial terms arising from the row upstream either of the nominal operator (of the same column), or of a redundant operator, destined for the nominal operator and the redundancy group associated with the row. For each row, the redundancy group is switched with the aid of two optical switches COM, so as to switch the processing pathways at input and at output. These optical switches carry out the switching between the assembly of the processing pathways for the nominal operators and the assembly of the processing pathways for the redundant operators.

This configuration makes it possible to substitute an available redundant operator for any failed nominal operator, and to do so within each row. The use of redundancy is more effective than in the case of the redundancy switching per entire column (or function).

The per-row redundancy capacity is exhausted when at least r+1 failed operators are concentrated in one and the same row. This system can therefore tolerate up to r×n1 failures of operators.

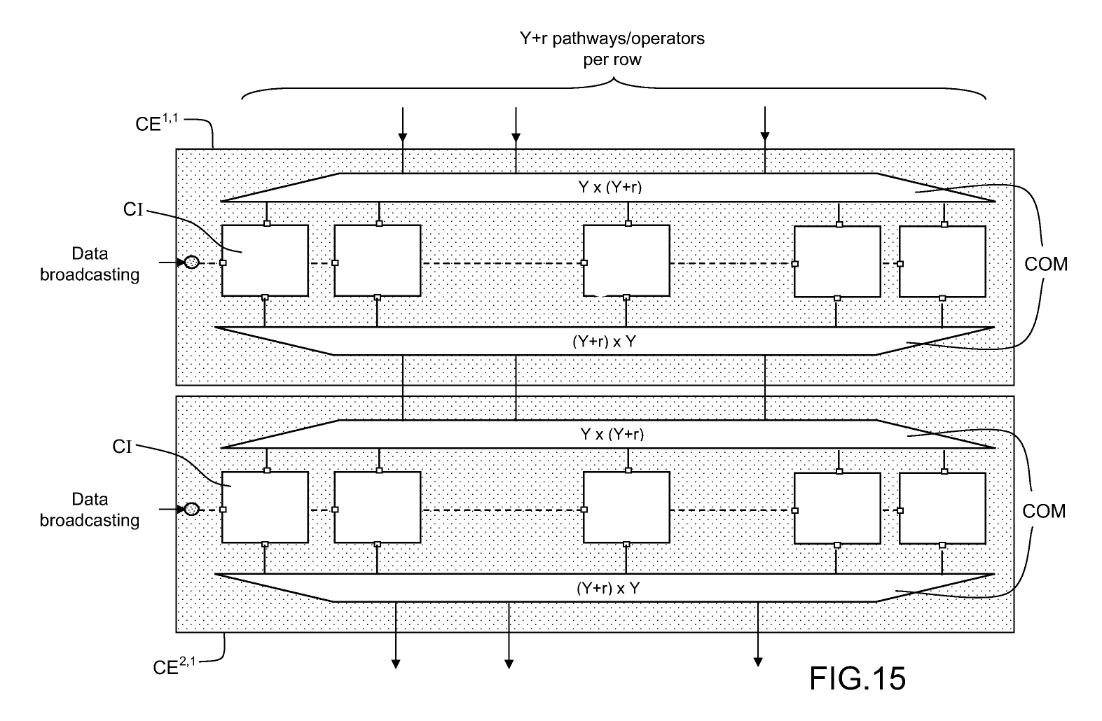

FIG. 15 illustrates a variant of FIG. 14, for switching the redundancies mutualized separately per row (or sub-function) consisting of a homogeneous architecture of undifferentiated operators.

This variant is more regular than the system of FIG. 14, without requiring optical couplers on the (vertical) processing pathways. On the other hand, the complexity of the optical switches COM is increased, while remaining very acceptable on account of better symmetry of the numbers of input and output ports (r being smaller than Y).

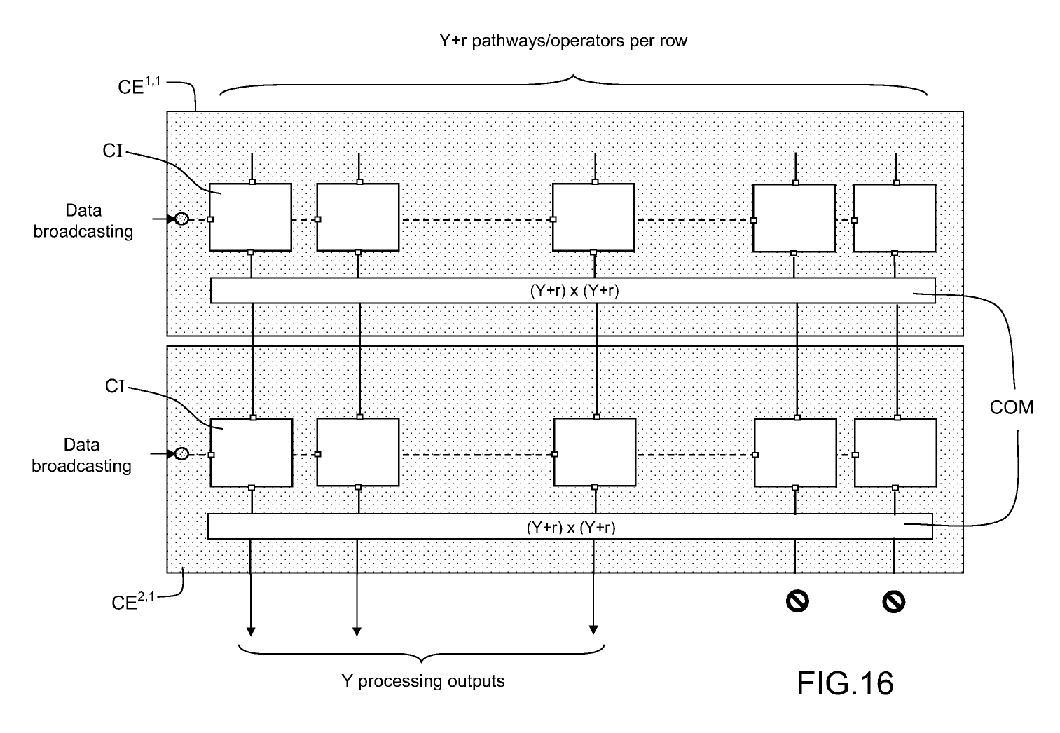

FIG. 16 illustrates another variant of FIGS. 14 and 15 for switching the redundancies mutualized separately per row (or sub-function). The system of FIG. 15 may be modified to dispense with one of the two optical switches COM per row of operators. This variant consists in propagating Y+r processing pathways along the whole of the vertical processing chain, with an optical switch COM at each row so as to define the connectivity with the operators of the following row.

At the output of the last row of operators, only Y physical outputs are retained. With half as many switches COM, this variant is simpler than the previous one, the propagation of Y+r pathways instead of Y (useful) pathways not being penalizing (r<<Y). On the other hand, the complexity of the optical switches COM is slightly increased, without posing any difficulties in practice, on account of the symmetry of the numbers of input and output ports and since Y+r is hardly different from Y.

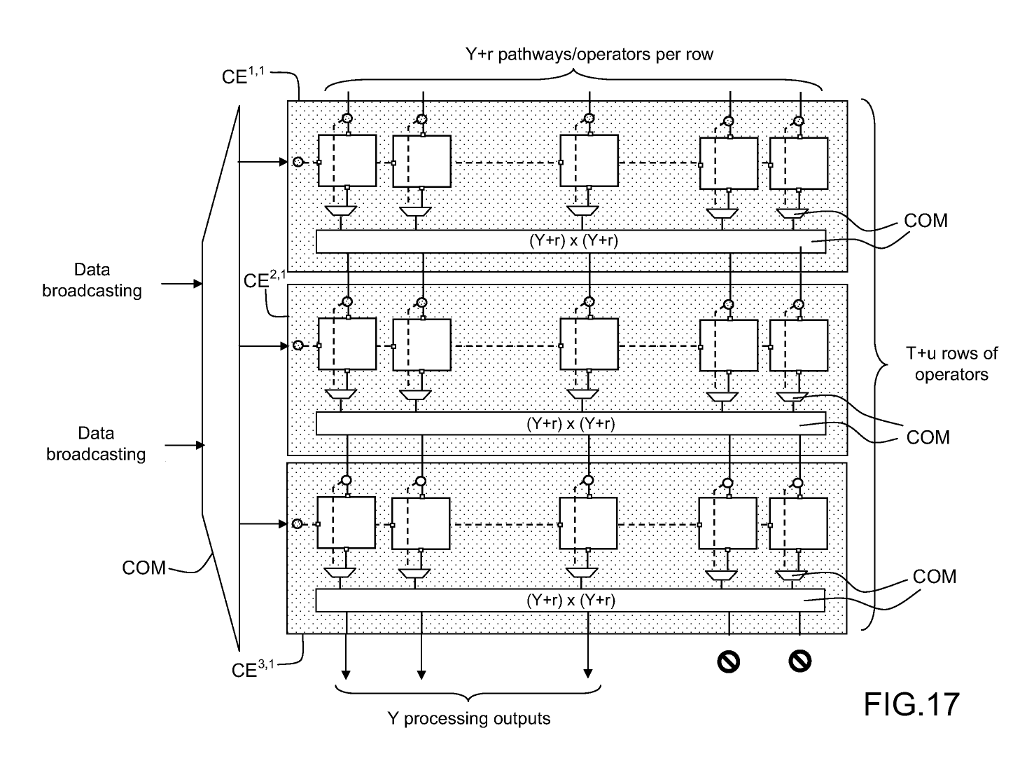

FIG. 17 illustrates a variant of the systems of FIGS. 14, 15 and 16, for switching the redundancies mutualized separately per row (or sub-function). In order to improve the tolerance to failures of the operators, this variant consists in considering provision for redundant rows as a supplement to the T nominal rows of operators which each already integrate r redundant operators.

Starting from the third variant, the redundancy capacity is increased by adding u redundant rows to the T rows of operators. This makes it possible to replace up to u rows of operators whose redundancy capacity has been exhausted (i.e. more than r failed operators).

An optical switch COM at the data side input carries out the switching of the T rows of inputs to the assembly of T+u rows of operators. An operator row may be unused, either when dealing with an inactive redundancy, or when the redundancy capacity of this row is exhausted by an excess of failures. In this case, the (vertical) flows of partial terms arising from the upstream rows must pass through the inactive row in a transparent manner. A solution consists in locally distributing each upstream partial term flow via a coupler to an input and two outputs distributing to each operator as well as to a so-called bypass pathway. A switch COM with two inputs and an output downstream of the operator makes it possible to select either the operator's processing output, or the bypass pathway, at input of the output switch Y+r:Y+r.

This solution offers better redundancies usage effectiveness than the variant managing the redundancy per row, at the price of increased complexity. Indeed, on top of the capacity to support up to any r failures per row, the addition of u redundant rows makes it possible furthermore to support up to u rows with more than r failures.

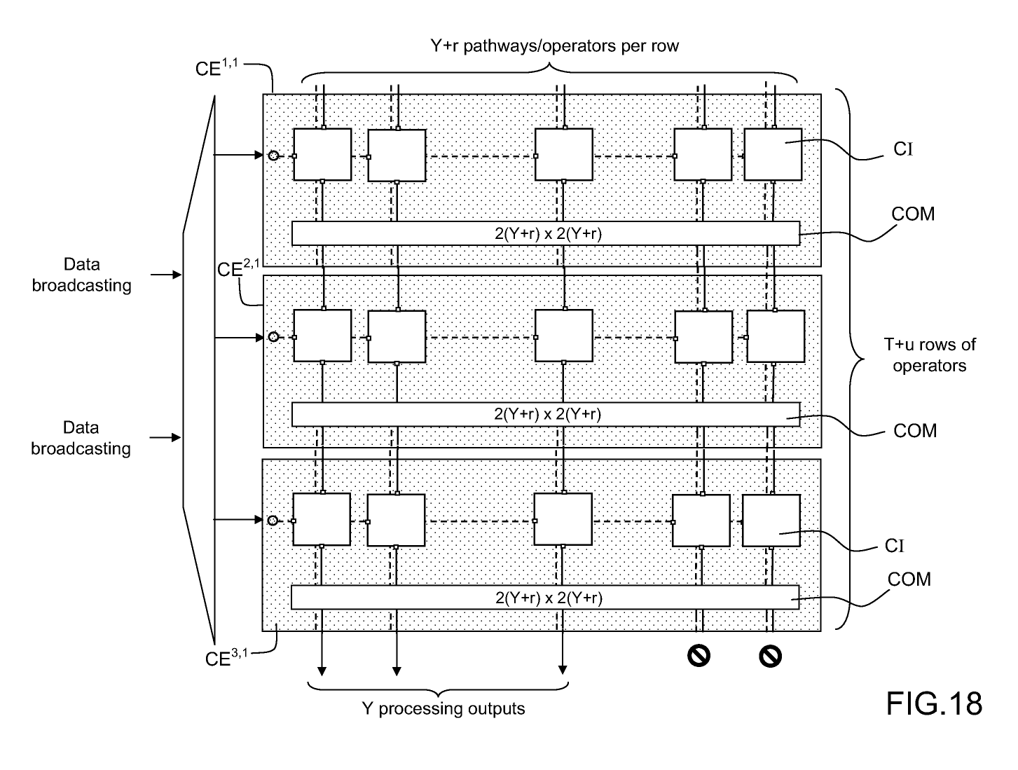

FIG. 18 illustrates a variant of the systems of FIGS. 14, 15, 16 and 17 for switching the redundancies mutualized separately per row (or sub-function). According to this variant, the optical couplers with an input and two outputs and the small optical switches COM with two inputs and an output are replaced with an extension of the capacity of the output switch, so as to switch Y+r bypass pathways in addition, i.e. a capacity of 2(Y+r): 2(Y+r). This solution allows the same redundancies usage effectiveness as the previous variant, but exhibits a simpler architecture, with optical communications of greater capacity.

The optical interfaces of FIGS. 14, 15, 16, 17 and 18 can transport either a data stream associated with a transceiver or fast serial interface element (“High Speed Serial Link transceiver”), or advantageously a multiplexing of data flows arising from an assembly of fast serial transceivers located in one and the same operator (integrated circuit/hybrid module/digital card/item of equipment).

A known variant for multiplexing data flows on an optical pathway is wavelength division multiplexing (WDM), each data flow being carried by a specific wavelength.

The use of WDM wavelength multiplexing on the proposed schemes is particularly effective since it makes it possible to directly reduce the density of optical interconnections, and as a consequence the complexity of the optical switches COM. Multiplexing relates to data flows apportioned according to one and the same topology, this being the case for the matrix digital architectures such as defined, both for the distributing of the data pathways and for the apportioning of the processing pathways (partial terms).

1. A system of at least one assembly (E^{a,b}) of at least one integrated circuit (CI_{i,j}^{a,b}), the system comprising:
at least two integrated circuits (CI_{i,j}^{a,b}) being interconnected according to a matrix architecture of n1 rows and n2 columns of integrated circuits (CI_{i,j}^{a,b}), a row (k) receiving at least one input for signals, and a column (I) providing at least one output for signals, the interconnections between two integrated circuits of a row (k) of one and the same assembly and the interconnections between two integrated circuits of a column (I) of one and the same assembly (E^{a,b}) being electrical, and
an assembly of at least one integrated circuit (CI_{i,j}^{a,b}) comprising at least one input integrated circuit comprising at least one input of the said assembly and at least one output integrated circuit comprising at least one output of the said assembly, an input integrated circuit being able optionally to be an output integrated circuit, and
at least one optical interconnection (IO) for connecting an input of a row of the system to a respective input of the input integrated circuits of the assemblies belonging to the said row (k), or for connecting a respective output of the output integrated circuits of the assemblies belonging to a column (I) of the system to the system output of the said column (I).

2. The system according to claim 1, in which an assembly (E^{a,b}) of at least one integrated circuit (CI_{i,j}^{a,b}) is implanted in a single electronic card (CE^{a,b}).

3. The system according to claim 1, in which an optical interconnection (IO) comprises an optical coupler (CO) and/or active optoelectronic coupling means and an optical link (LO) per input of input integrated circuit of the assemblies of a row (k) or per output of output integrated circuit of the assemblies of a column (I).

4. The system according to claim 1, in which at least one row (k) optical interconnection (IO) further comprises a test optical link (LOT).

5. The system according to claim 1, in which an optical link (LO) comprises optical fibre.

6. The system according to claim 1, in which at least one row (k) optical interconnection (IO) further comprises an optical amplifier (AO).

7. The system according to claim 1, in which several row (k) optical interconnections (IO) are linked at input by at least one optical switch (COM), and/or several column (I) optical interconnections (IO) are linked at output by at least one optical switch (COM).

8. The system according to claim 1, in which at least one optical link (LO) is adapted for carrying out a wavelength division multiplexing.

9. The system according to claim 1, comprising at least one assembly of integrated circuits as redundancy, featuring optical links (LO).

10. The system according to claim 1, adapted for carrying out a function of digital beam forming of phased array antenna.

11. The system according to claim 1, adapted for carrying out a switching function.

12. A processor comprising at least one system according to claim 1.

13. A satellite comprising at least one processor according to claim 10.

14. A method for interconnecting a system of at least one assembly (E^{a,b}) of at least one integrated circuit (CI_{i,j}^{a,b}), comprising at least two integrated circuits (CI_{i,j}^{a,b}), according to a matrix architecture of n1 rows and n2 columns of integrated circuits, a row (k) receiving at least one input for signals, and a column (I) providing at least one output for signals, the interconnections between two integrated circuits of a row (k) of one and the same assembly and the interconnections between two integrated circuits of a column (I) of one and the same assembly being carried out electrically, and an assembly (E^{a,b}) of at least one integrated circuit comprising at least one input integrated circuit comprising at least one input of the said assembly and at least one output integrated circuit comprising at least one output of the said assembly, an input integrated circuit being able optionally to be an output integrated circuit, the method comprising the steps of:
at least one input of a row (k) of the system is interconnected optically to a respective input of the input integrated circuits of the assemblies, belonging to the said row (k), or at least one output of a column (I) of the system is interconnected optically to a respective output of the output integrated circuits of the assemblies, belonging to the said column (I).
